(19) United States
(12) Patent Application Publication
(10) Pub. No.: US 2005/0048262 A1
(43) Pub. Date: Mar. 3, 2005

(54) Production method of antistatic plate with anti-glare property, and antistatic plate produced thereby

(75) Inventors: Yoshimi Nakagawa, Kyoto-shi (JP); Tomohiro Mizumoto, Niihama-shi (JP)

Correspondence Address: FOLEY AND LARDNER;SUITE 500, 3000 K STREET NW, WASHINGTON, DC, 20007, US

(73) Assignee: SUMITOMO CHEMICAL COMPANY, LIMITED

(21) Appl. No.: 10/923,043

(22) Filed: Aug. 23, 2004

(30) Foreign Application Priority Data
Aug. 28, 2003 (JP) 2003-209261

(51) Int. Cl. B32B 27/18; B32B 27/30

(52) U.S. Cl. 428/142; 428/522

(57) ABSTRACT

An antistatic plate is produced in the method comprising the steps of i) applying on an rough surface of a substrate, a coating material containing a curable compound and conductive particles and having a viscosity of from about 3 mPa·s to about 6 mPa·s at 25° C., and ii) curing the coating material. The antistatic plate has proper anti-glare property and transparency, and has good visibility of images as a front plate for an image display apparatus.

### BACKGROUND OF THE INVENTION

1. Field of the Invention

The invention relates to an antistatic plate with anti-glare property and a production method of the antistatic plate.

2. Description of the Related Art

An antistatic plate has been widely used as a front plate for an image display apparatus such as a screen for a projection television. It is known that the antistatic plate can be produced by a method in which the surface of a substrate made of glass or resin is coated with an antistatic coating material, which is then cured to form an antistatic layer. As the coating material herein, for example, JP-A-8-20734 (1996) discloses a conductive coating material containing antimony-doped tin oxide particles and a binder. Further, JP-A-11-343430 (1999) discloses a conductive coating material containing a polyfunctional (meth)acrylate and conductive particles. In addition, JP-A-2002-248712 discloses that a composition containing organic or inorganic beads and a radiation-curable resin is utilized to form an antistatic layer having an rough surface, thereby providing anti-glare property.

The antistatic plates obtained by the methods disclosed in JP-A-8-20734 (1996) and JP-A-11-343430 (1999) are easy to reflect outer light and, therefore, when the plates are used as a front plate for an image display apparatus, images are sometimes difficult to be seen. On the other hand, the antistatic plate obtained by the method disclosed in JP-A-2002-248712 has a large haze and, when it is used as a front plate for an image display apparatus, the images tend to become whitish.

The present inventors have enthusiastically carried out investigations for developing an antistatic plate having proper anti-glare property and transparency, which is excellent in visibility of images as a front plate for an image display apparatus. As a result, the present inventors have found that an antistatic plate satisfying the above-mentioned objects can be obtained using a substrate having an rough surface and a conductive coating material containing a curable compound and conductive particles. The present invention has been accomplished by the findings.

### SUMMARY OF THE INVENTION

The invention provides a method for producing an antistatic plate, the method comprising the steps of applying on an rough surface of a substrate, a coating material containing a curable compound and conductive particles and having a viscosity of from about 3 mPa·s to about 6 mPa·s at 25° C., and curing the coating material; and also provides an antistatic plate obtainable by the method.

Further, the invention provides an antistatic plate in which each of 20-degree specular glossiness and 60-degree specular glossiness is in a range of about 100% to about 140%, and surface resistivity is about 1×10¹³ Ω/□ or less.

### DETAILED DESCRIPTION OF THE INVENTION

An antistatic plate in the present invention comprises a substrate and an antistatic layer obtainable by curing a coating material.

The substrate has at least one rough surface. The rough surface may be formed in both faces of the substrate or may be formed in only one face of the substrate.

The degree of roughness of the substrate surface can be expressed with a specular glossiness to an incident light. The substrate used in the present invention preferably has a specular glossiness to an incident light with 200 incident angle (i.e., 20-degree specular glossiness) in the range of from about 80% to about 120%. Also, the substrate preferably has a specular glossiness to an incident light with 60° incident angle (i.e., 60-degree specular glossiness) in the range of from about 80% to about 120%. An antistatic plate with suitable transparency and anti-glare property can be advantageously produced by using the substrate having such glossiness.

Further, the degree of roughness of the substrate surface can be expressed with Arithmetic Mean Deviation of the Profile (Ra). The substrate used in the present invention preferably has a Arithmetic Mean Deviation of the Profile in the range of form about 0.5 μm to about 2.5 μm.

The raw material of the substrate may be glass or a transparent resin such as acrylic resin, polycarbonate resin and polystyrene resin. In terms of the hardness and glossiness, acrylic resin and polystyrene resin are preferred, and especially, acrylic resin is more preferred. The acrylic resin may be a homopolymer of methyl methacrylate or may be a copolymer of methyl methacrylate with another monomer (such as a copolymer of methyl methacrylate with acrylic acid ester, and a copolymer of methyl methacrylate with styrene). The polystyrene resin may be a homopolymer of styrene or may be a copolymer of styrene with another monomer.

The thickness of the substrate is appropriately adjusted depending on the use of the resulting antistatic plate. From a viewpoint of stiffness, the thickness is preferably about 0.5 mm or more and, from a viewpoint of the lightweight and the cost, the thickness is preferably about 20 mm or less.

The substrate having the above-described rough surface in the present invention can be produced, for example, by an extrusion molding method using a roll having an rough surface, an injection molding method using a mold having an rough inner face, and a bulk polymerization method using a cell having an rough inner face.

In the present invention, a cured layer serving as an antistatic layer may be formed on the above-described substrate in a manner such that a coating material containing a curable compound and conductive particles is applied on the rough surface of the substrate, and the applied coating material is then cured on the substrate. As a result of forming such an antistatic layer on the rough surface of the substrate, an antistatic plate having anti-glare properties besides antistatic properties can be obtained.

The coating material may have a viscosity of from about 3 mPa·s to about 6 mPa·s at 25° C., preferably has a viscosity of from about 4 mPa·s to about 6 mPa·s at 25° C. Such a coating material can provide an antistatic layer on the substrate so as to appropriately moderate the roughness of the substrate surface and to produce an antistatic plate having suitable anti-glare property and transparency. When a coating material with a lower viscosity than the above range is utilized on the substrate, it is difficult to moderate the roughness of the substrate so much, and the resulting antistatic plate tends to have a large haze. If such an antistatic plate with a large haze is used as the front plate for an image display apparatus, the images of the display tend to become whitish. On the other hand, when a coating material with a higher viscosity than the above range is utilized on the substrate, the roughness of the substrate may be so much moderated as to provide an antistatic plate easily reflecting the outside light. If such an antistatic plate easily reflecting the outside light is used as a front plate for an image display apparatus, the images tend to be hard to see. Moreover, since leveling property of the resulting coating layer tends to be insufficient, it easily results in inferior appearance.

In addition, from a viewpoint of the leveling of the resulting coating layer as an antistatic layer, the surface tension of the coating material is preferably about 25 mPa·m or more at 25° C. and, further, the ratio of the above-mentioned viscosity to the surface tension (i.e., viscosity/surface tension) is preferably about 0.2 s/m or less.

The curable compound, one of the components contained in the coating material in the present invention, may be properly selected from commonly known curable binders utilized in coating. In particular, the compound having at least three (meth)acryloyloxy groups in a molecule thereof is preferably used as the curable compound, in terms of scratch-resistance properties of the resulting antistatic layer. Here, the term “(meth)acryloyloxy groups” represents both acryloyloxy groups and methacryloyloxy groups, and hereinafter, the term “(meth)” has an analogous meaning indicating the optional presence of a methyl substituent.

Examples of the compound having at least three (meth)acryloyloxy groups in a molecule thereof may include trimethylolpropane tri(meth)acrylate, trimethylolethane tri(meth)acrylate, pentaerythritol tri(meth)acrylate, pentaerythritol tetra(meth)acrylate, glycerin tri(meth)acrylate, dipentaerythritol tri(meth)acrylate, dipentaerythritol tetra(meth)acrylate, dipentaerythritol penta(meth)acrylate, dipentaerythritol hexa(meth)acrylate, tris[(meth)acryloyloxyethyl]isocyanurate and the like.

In addition, examples of the compound having at least three (meth)acryloyloxy groups in a molecule thereof further include a phosphazene (meth)acrylate compound obtained by introducing at least three (meth)acryloyloxy groups into a phosphazene ring; a urethane (meth)acrylate compound obtained by reaction of a compound having at least two isocyanato groups in a molecule thereof with a compound having a hydroxyl group and at least two (meth)acryloyloxy groups in a molecule thereof; a urethane (meth)acrylate compound obtained by reaction of a compound having one isocyanato group in a molecule thereof with a compound having a hydroxyl group and at least three (meth)acryloyloxy groups in a molecule thereof; and a polyester (meth)acrylate compound obtained by reaction of a compound having at least two halocarbonyl groups in a molecule thereof with a compound having a hydroxyl group and at least two (meth)acryloyloxy groups in a molecule thereof.

Further, oligomers such as dimers and trimers of the above compounds can be used as the compound having at least three (meth)acryloyloxy groups in a molecule thereof.

The compound having at least three (meth)acryloyloxy groups in a molecule thereof may be use alone, or two or more of them may be used together.

Examples of commercially available product of the compound having at least three (meth)acryloyloxy groups in its molecule may include NK Hard M101 (urethane acrylate compound); NK Ester A-TMM-3L (pentaerythritol triacrylate), NK Ester A-9530 (dipentaerythritol hexaacrylate), all being made by Shin-Nakamura Chemical Co., Ltd.; KAYARAD DPCA (dipentaerythritol hexaacrylate) made by Nippon Kayaku Co., Ltd.; Aronix M-8560 (polyester acrylate compound) made by Toagosei Co., Ltd.; New frontier TEICA (tris(acryloyloxyethyl)isocyanurate) made by Dai-ichi Kogyo Seiyaku Co., Ltd.; PPZ (phosphazene methacrylate compound) made by Kyoeisha Chemical Co., Ltd., and the like.

In the coating material, other kinds of curable compound can be used in combination with the compound having at least three (meth)acryloyloxy groups in its molecule in order to provide flexibility to the resulting antistatic layer. Examples of such a curable compound may include compounds having one (meth)acryloyloxy group in its molecule, such as (meth)acrylic acid, methyl(meth)acrylate, ethyl(meth)acrylate, butyl(meth)acrylate, n-hexyl(meth)acrylate, cyclohexyl(meth)acrylate, and 2-ethylhexyl(meth)acrylate; and compounds having two (meth)acryloyloxy groups in its molecule, such as ethylene glycol di(meth)acrylate, diethylene glycol di(meth)acrylate, 1,6-hexanediol di(meth)acrylate, and neopentyl glycol di(meth)acrylate.

Further, the following curable compounds other than the compound having (meth)acryloyloxy groups in its molecule may also be used, that is, the compound such as styrene, methylstyrene, chlorostyrene, bromostyrene, maleic acid, maleic anhydride, maleimide, N-methylmaleimide and N-vinylpyrrolidone are also used with the compound having at least three (meth)acryloyloxy groups in its molecule in the coating material.

In the case of using the compound having at least three (meth)acryloyloxy groups in its molecule and other curable compound in combination, the amount of the latter is preferably about 50 parts by weight or less per 100 parts by weight of the former, in terms of the surface hardness of the resulting antistatic layer.

Conductive particles are contained in a coating material in the present invention. Examples of conductive particles may include inorganic particles of antimony-doped tin oxide, phosphorus-doped tin oxide, antimony oxide, zinc antimonate, titanium oxide, ITO (indium tin oxide) and the like, and two or more of them may be used, if necessary.

The conductive particles preferably have an average particle diameter of about 0.01 m or less, and more preferably have an average particle diameter of about 0.008 μm or less. The conductive particles with such a small diameter may improve transparency of the resulting antistatic layer, which results in improving transparency of the antistatic plate. Also, when such conductive particles are utilized in a coating material, the amount of the conductive particles can be saved, which result in reducing the production cost. Incidentally, the conductive particles may exist in the form of agglomerated particles in the coating material and/or in the antistatic layer. The average particle diameter of the agglomerated particles is preferably about 0.1 μm or less.

The conductive particles can be produced by, for example, a vapor phase decomposition method, a plasma evaporation method, an alkoxide decomposition method, a coprecipitation method, a hydrothermal method or the like. The surfaces of the conductive particles may be treated with, for example, a nonionic surfactant, a cationic surfactant, an anionic surfactant, a silicon type coupling agent, an aluminum type coupling agent or the like.

The amount of the conductive particles in the coating material may be in the range of from about 1 part by weight to about 20 parts by weight, and is preferably in the range of from about 2 parts by weight to about 10 parts by weight, per 100 parts by weight of the curable compound contained together. When the amount is too small, the antistatic effect of the resulting antistatic layer tends to be insufficient. When the amount is too large, the scratching resistance of the antistatic layer may be insufficient in some cases.

The coating material may contain a solvent. Any solvent can be used as long as it can dissolve or disperse the curable compound and the conductive particles and can be evaporated after applied onto the substrate. The examples of the solvent may include water and organic solvents, for example, alcohols such as diacetone alcohol, methanol, ethanol, and isopropyl alcohol; ketones such as acetone, methyl ethyl ketone, and methyl isobutyl ketone; aromatic hydrocarbons such as toluene and xylene; and esters such as ethyl acetate. The mixture of these solvents may also be used. The amount of the solvent contained in the coating material may be in the range of from about 25 parts by weight to about 900 parts by weight per 100 parts by weight of the curable compound contained together.

The preparation method of the coating material is not particularly limited. The coating material may be prepared by mixing a curable compound, conductive particles and an optional solvent, and if needed, other components, and the viscosity of the resulting mixture is adjusted so as to fall within the above-mentioned range. The viscosity may be adjusted to be in the above-mentioned range by a method of first preparing a coating material with a viscosity lower than the range using a relatively large amount of a solvent and then evaporating the solvent to obtain the viscosity within the range.

Examples of the method for applying the coating material on the rough surface of the substrate may include a dipping method, a bar coater method, a roll coater method and the like.

An antistatic layer in the present invention can be formed by curing the coating material applied on the rough surface of the substrate. The curing method may be selected appropriately depending on the curing mechanism of the curable compound in the coating material. For example, when the above-mentioned compound having at least three (meth)acryloyloxy groups in its molecule is used as a curing compound, a method of radiating energy beam such as electron beam, radioactive beam, and UV rays is preferably employed. When the coating material contains a solvent, the energy beam may be irradiated to the coating material on the substrate after evaporation of the solvent, before evaporation or simultaneously with evaporation, to cure the coating material.

To smoothly promote the curing, a polymerization initiator or a sensitizer may be used and, in this case, the polymerization initiator or the sensitizer may be added to the coating material when the coating material is prepared. Examples of the polymerization initiator may include phenyl ketone compounds and benzophenone compounds. Examples of the commercially available polymerization initiator may include Irgacure 184 made by Ciba Specialty Chemicals; Darocur 1173 made by Merck Ltd., Japan; and Ezacure KIP100F made by Nihon SiberHegner K.K. Examples of the commercially available sensitizer may include Ezacure EDB made by Nihon SiberHegner K.K.

The resulting cured layer as an antistatic layer can be thus formed on the substrate to produce an antistatic plate in the present invention. The thickness of the layer may be in the range of from about 1 m to about 20 μm, and is preferably in the range of from about 4 μm to about 9 μm. When the thickness is too thin, the scratch resistance of the layer may be insufficient in some cases. On the other hand, when the thickness is too thick, the transparency of the layer tends to become low, and the anti-glare property of the layer tends to be inferior in some cases.

An antistatic plate produced as described above using the substrate and the coating material has proper anti-glare property and transparency, so that the antistatic plate of the present invention can be used preferably for a display front plate such a screen for a projection television and for a display-window-protection plate of a portable information terminal such as a cellular phone. Incidentally, the antistatic plate of the present invention may be formed so as to have curved shape depending on the case where the plate is utilized.

The production method described above can suitably provide the antistatic plate having a 20-degree specular glossiness and a 60-degree specular glossiness both in the range of from about 100% to about 140%, and having a surface resistivity of about 1×10¹³ Ω/□ or less. The antistatic plate has a glossiness in the above range and is excellent in the balance of transparency and anti-glare properties. Since the antistatic plate has low surface resistivity, dust is scarcely attached to the plate. Accordingly, the antistatic plate is especially suitable as a front plate for image display apparatus.

As described above, the antistatic plate in the present invention has proper anti-glare property and transparency, and has good visibility of images as a front plate for an image display apparatus.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2003-209261 filed on Aug. 28, 2003, including specification, claims and summary, are incorporated herein by reference in their entirety.

### EXAMPLES

The present invention is described in more detail by following Examples, which should not be construed as a limitation upon the scope of the present invention.

In the following Examples and Comparative Examples, content (%) and amount (parts) of a compound to be used are on the basis of weight thereof, except otherwise provided.

The physical properties of obtained coating materials, substrates and antistatic plates were measured as follows.

(1) Viscosity of Coating Material

In accordance with JIS K7117-1 (1999), viscosity of the coating material was measured at 25° C. using a B-type viscometer (DVM-BII, manufactured by TOKIMEC Inc.)

(2) Surface Tension of Coating Material

Surface tension of the coating material Measurement was measured at 25° C. using a dynamic probe (WET-6000, manufactured by Rhesca Co., Ltd.)

(3) Specular Glossiness of Substrate and Antistatic Plate

In accordance with JIS Z 8741 (1997), 20-degree specular glossiness and 60-degree specular glossiness of the substrate and the antistatic plate were measured using a glossmeter (GM-268, manufactured by Minolta).

(4) Total Light Transmittance and Haze of Substrate and Antistatic Plate

In accordance with JIS K 7105 (1981), total light transmittance and haze of the substrate and the antistatic plate were measured by using a haze, transmittance and reflection meter (HR-100, manufactured by Murakami Color Research Lab.), in which the rough face of the substrate/plate was set as the light emission face.

(5) Surface Resistivity of Antistatic Plate

In accordance with JIS K 6911 (1995), the surface resistivity of the rough surface (i.e., the side on which the rough surface is places) of the antistatic plate was measured by using a surface resistivity meter (TOA ULTRA MEGOHMMETER SM-8210, manufactured by To a Denpa Kogyo Co., Ltd.).

### Example 1

(A) Preparation of Coating Material

One hundred (100) parts of a conductive particle-containing curable composition (Sumicefine ASP-SK 1, made by Sumitomo Osaka Cement Co., Ltd.) containing 1.5% of antimony-doped tin oxide (average primary particle diameter: 0.005 μm), 16.5% of dipentaerythritol hexaacrylate, 5% of cyclohexyl acrylate, 4% of N-vinylpyrrolidone, 3% of 2-methyl-1-[4-(methylthio)phenyl]-2-morpholinopropan-1-one (as a photopolymerization initiator), 45% of methyl ethyl ketone, and 15% of diacetone alcohol was mixed with 16.7 parts of dipentaerythritol hexaacrylate (NK Ester A-9530, made by Shin-Nakamura Chemical Co., Ltd.), 4.8 parts of methyl ethyl ketone, and 14.3 parts of diacetone alcohol to obtain a coating material. The coating material had a viscosity of 2.5 mPa·s, a surface tension of 31 mPa·m, and a viscosity/surface tension ratio of 0.08 s/m. Then, the coating material was stirred at a room temperature to evaporate a portion of the solvents, to obtain a coating material having a viscosity of 4 mPa·s, a surface tension of 32 mPa·m and a viscosity/surface tension ratio of 0.12 s/m.

(B) Production of Antistatic Plate

An acrylic resin plate having an rough face in one side (SumipexMT007, made by Sumitomo Chemical Co., Ltd., thickness: 2 mm) was used as a substrate. The specular glossiness, the total light transmittance and the haze of the substrate are shown in Table 1. The above-prepared coating material was applied to both surfaces of the substrate by using a precision dipping apparatus, dried and then cured by UV radiation to produce an antistatic plate. The cross-sectional photograph of the antistatic plate was taken by a transmission electron microscope (TEM, 20,000 magnification) to find that an about 5.7 μm-thick cured coating layer (an antistatic layer) was formed on each of both surfaces of the substrate. In the layer, antimony-doped tin oxide was agglomerated and arranged in mesh-like state. The specular glossiness, the total light transmittance and the haze of the antistatic plate are shown in Table 1. When the antistatic plate was installed in front of a projection television while the rough face was set to the observer side, good images were observed.

### Example 2

A coating material having a viscosity of 5.1 mPa·s, a surface tension of 32 mPa·m and a viscosity/surface tension ratio of 0.16 s/m was obtained in the same manner as in Example 1 except that the stirring condition of the first obtained coating material having a viscosity of 2.5 mPa·s and a surface tension of 31 mPa·m was changed so as to change the evaporation amount of the solvents. Using the coating material, an antistatic plate was produced in the same manner as in Example 1. The cross-sectional photograph of the antistatic plate was taken by a transmission electron microscope (TEM, 20,000 magnification) to find that an about 4.5 μm-thick cured coating layer (an antistatic layer) was formed on each of both surfaces of the substrate. In the layer, antimony-doped tin oxide was agglomerated and arranged in mesh-like state. The specular glossiness, the total light transmittance and the haze of the antistatic plate are shown in Table 1. When the antistatic plate was installed in front of a projection television while the rough face was set to the observer side, good images were observed.

### Comparative Example 1

A coating material having a viscosity of 2.8 mPa·s, a surface tension of 31 mPa·m, and a viscosity/surface tension ratio of 0.09 s/m was obtained in the same manner as in Example 1 except that the stirring condition of the first obtained coating material having a viscosity of 2.5 mPa·s and a surface tension of 31 mPa·m was changed so as to change the evaporation amount of the solvents. Using the coating material, an antistatic plate was produced in the same manner as Example 1. The cross-sectional photograph of the antistatic plate was taken by a transmission electron microscope (TEM, 20,000 magnification) in the same manner as Example 1, to find that an about 3.4 μm-thick cured coating layer (an antistatic layer) was formed on each of both surfaces of the substrate. In the layer, antimony-doped tin oxide was agglomerated and arranged in mesh-like state. The specular glossiness, the total light transmittance and the haze of the antistatic plate are shown in Table 1. When the antistatic plate was installed in front of a projection television while the rough face was set to the observer side, images could not be seen clearly owing to rainbow-like pattern formation.

### Comparative Example 2

A coating material having a viscosity of 6.5 mPa·s, a surface tension of 31 mPa·m, and a viscosity/surface tension ratio of 0.21 s/m was obtained in the same manner as in Example 1 except that the stirring condition of the first obtained coating material having a viscosity of 2.5 mPa·s and a surface tension of 31 mPa·m was changed so as to change the evaporation amount of the solvents. Using the coating material, an antistatic plate was produced in the same manner as Example 1. The cross-sectional photograph of the antistatic plate was taken by a transmission electron microscope (TEM, 20,000 magnification) in the same manner as Example 1, to find that an about 10.0 μm-thick cured coating layer (an antistatic layer) was formed on each of both surfaces of the substrate. In the layer, antimony-doped tin oxide was agglomerated and arranged in mesh-like state. The specular glossiness, the total light transmittance and the haze of the antistatic plate are shown in Table 1. The antistatic plate was installed in front of a projection television while the rough face was set to the observer side, images could not be seen clearly owing to considerably intense reflection of the outside light.

TABLE 1

| | Sub- | | | Comparative | Comparative |
|---|---|---|---|---|---|
| | strate | Example 1 | Example 2 | Example 1 | Example 2 |
| 20-degree | 82 | 113 | 127 | 88 | 145 |
| specular | | | | | |
| glossiness | | | | | |
| (%) | | | | | |
| 60-degree | 94 | 125 | 133 | 107 | 143 |
| specular | | | | | |
| glossiness | | | | | |
| (%) | | | | | |
| Total light | 90.5 | 89.9 | 89.7 | 90.0 | 90.1 |
| transmittance | | | | | |
| (%) | | | | | |
| Haze (%) | 56 | 0.6 | 0.7 | 0.8 | 0.8 |
| Surface | — | 1.1 × 10¹⁰ | 3.9 × 10¹⁰ | 1.3 × 10¹⁰ | 5.0 × 10¹⁰ |
| resistivity | | | | | |
| (Ω/□) | | | | | |

1. A method for producing an antistatic plate, the method comprising the steps of:
applying on an rough surface of a substrate, a coating material containing a curable compound and conductive particles and having a viscosity of from about 3 mPa·s to about 6 mPa·s at 25° C.; and
curing the coating material.

2. The method according to claim 1, wherein the rough surface of the substrate has a 20-degree specular glossiness in the range of about 80% to about 120% and 60-degree specular glossiness in the range of about 80% to about 120%.

3. The method according to claim 1, wherein the substrate is an acrylic resin plate.

4. The method according to claim 1, wherein the curable compound has at least three (meth)acryloyloxy groups in a molecule thereof.

5. The method according to claim 1, wherein the conductive particles have an average particle diameter of about 0.01 μm or less.

6. An antistatic plate in which each of 20-degree specular glossiness and 60-degree specular glossiness is in the range of about 100% to about 140%, and surface resistivity is about 1×10¹³ Ω/□ or less.

7. An antistatic plate comprising a substrate having at least one rough surface and a cured layer, the antistatic plate obtainable by curing, on the substrate, a coating material containing a curable compound and conductive particles and having a viscosity at 25° C. of from about 3 mPa·s to 6 about mPa·s.
